(19) United States
(12) Patent Application Publication
(10) Pub. No.: US 2022/0416293 A1
(43) Pub. Date: Dec. 29, 2022

(54) SOLID ELECTROLYTE, LITHIUM ION ENERGY STORAGE DEVICE, AND ENERGY STORAGE APPARATUS

(71) Applicant: GS Yuasa International Ltd., Kyoto-shi, Kyoto (JP)

(72) Inventor: Daisuke YOSHIKAWA, Kyoto (JP)

(21) Appl. No.: 17/777,880

(22) PCT Filed: Nov. 5, 2020
(86) PCT No.: PCT/JP2020/041273

§ 371 Date: May 18, 2022

(30) Foreign Application Priority Data
Dec. 10, 2019 (JP) 2019-223189

(51) Int. Cl. H01M 10/0562; H01M 10/0525

(52) U.S. Cl. CPC H01M 10/0562; H01M 10/0525; H01M 2300/008

(57) ABSTRACT

One aspect of the present invention is a solid electrolyte which has a crystal structure attributable to a space group F-43m and contains lithium, phosphorus, sulfur, and an element A, in which the element A is a metal element having an ionic radius of more than 59 pm and 120 pm or less in 4-fold coordination and 6-fold coordination in an ion crystal.

### TECHNICAL FIELD

The present invention relates to a solid electrolyte, a lithium ion energy storage device, and an energy storage apparatus.

### BACKGROUND ART

A lithium ion secondary battery is widely in use for electronic equipment such as personal computers and communication terminals, automobiles, and the like because the battery has high energy density. The lithium ion secondary battery generally includes a pair of electrodes, which are electrically separated from each other by a separator, and a nonaqueous electrolyte interposed between the electrodes, and is configured to allow lithium ions to be transferred between the two electrodes for charge-discharge. A capacitor such as a lithium ion capacitor is also widely in use as a lithium ion energy storage device except for the lithium ion secondary battery.

In recent years, as a nonaqueous electrolyte, an energy storage device using a solid electrolyte such as a sulfide-based solid electrolyte instead of a nonaqueous electrolyte solution in which an electrolyte salt is dissolved in a liquid such as an organic solvent has been proposed. As one of sulfide-based solid electrolytes, an Argyrodite-type solid electrolyte containing lithium, phosphorus, sulfur, and halogen is known (see Patent Documents 1 and 2 and Non-Patent Documents 1 and 2). This solid electrolyte is considered to have a crystal structure attributing to a space group F-43m.

### PRIOR ART DOCUMENTS

### Patent Documents

Patent Document 1: JP-A-2018-67552

Patent Document 2: JP-A-2017-117753

### Non-Patent Documents

Non-Patent Document 1: Prasada Rao Rayavarapu et al., “Variation in structure and Li+-ion migration in argyrodite-type Li₆PS₅X (X═Cl, Br, I) solid electrolytes”, JSolid State Electrochem 16 (2012) 1807-1813

Non-Patent Document 2: Sylvain Boulineau et al., “Mechanochemical synthesis of Li-argyrodite Li₆PS₅X (X═Cl, Br, I) as sulfur-based solid electrolytes for all solid state batteries application” Solid State Ionics 221 (2012) 1-5

### SUMMARY OF THE INVENTION

### Problems to be Solved by the Invention

In a solid electrolyte used for an energy storage device, ionic conductivity is one of important performances. On the other hand, the energy storage device is required to have various performances depending on a use environment, a use application, and the like, and for example, in consideration of use in a low temperature environment, it is desired that the energy storage device exhibits good charge-discharge performance even at a low temperature. Thus, even in the Argyrodite-type solid electrolyte, further improvement of the ionic conductivity at a low temperature (for example, −30° C.) is desired.

The present invention has been made based on the above circumstances, and an object of the present invention is to provide a solid electrolyte having excellent ionic conductivity at a low temperature, and a lithium ion energy storage device and an energy storage apparatus using such a solid electrolyte.

### Means for Solving the Problems

One aspect of the present invention made to solve the above problems is a solid electrolyte which has a crystal structure attributable to a space group F-43m and contains lithium, phosphorus, sulfur, and an element A, in which the element A is a metal element having an ionic radius of more than 59 μm and 120 μm or less in 4-fold coordination and 6-fold coordination in an ion crystal.

Another aspect of the present invention is a lithium ion energy storage device containing the solid electrolyte.

Another aspect of the present invention is an energy storage apparatus including two or more lithium ion energy storage devices, and one or more of the lithium ion energy storage devices according to another aspect of the present invention.

### Advantages of the Invention

According to the present invention, it is possible to provide a solid electrolyte having excellent ionic conductivity at a low temperature, and a lithium ion energy storage device using such a solid electrolyte.

### BRIEF DESCRIPTION OF THE DRAWINGS

FIG. 1 is a schematic cross-sectional view of an all-solid-state battery as an embodiment of a lithium ion energy storage device of the present invention.

FIG. 2 is a schematic view illustrating an energy storage apparatus configured by assembling a plurality of the lithium ion energy storage devices according to an embodiment of the present invention.

### MODE FOR CARRYING OUT THE INVENTION

A solid electrolyte according to an embodiment of the present invention is a solid electrolyte which has a crystal structure attributable to a space group F-43m and contains lithium, phosphorus, sulfur, and an element A, in which the element A is a metal element having an ionic radius of more than 59 μm and 120 μm or less in 4-fold coordination and 6-fold coordination in an ion crystal.

The solid electrolyte has excellent ionic conductivity at a low temperature. Although the reason why such an effect occurs is not clear, the following reason is presumed. The solid electrolyte has the crystal structure attributable to the space group F-43m, and further contains the element A as compared with a conventional solid electrolyte containing lithium, phosphorus, and sulfur. The element A is a metal element having an ionic radius of more than 59 μm and 120 μm or less in the 4-fold coordination and the 6-fold coordination in the ion crystal, and the range of the ionic radius is a range slightly larger than the ionic radius (59 μm) in the 4-fold coordination in the ion crystal of lithium. In a conventional solid electrolyte having the crystal structure attributable to the space group F-43m and containing lithium, phosphorus, and sulfur, lithium exists in a 4-fold coordination state at a 48h site in the ion crystal structure. When lithium is substituted with another element in such a solid electrolyte, it is considered that the other substituted element may enter the 48h site in the ion crystal to be four-coordinated or enter the other 4d site or the like to be six-coordinated. At this time, when the other element to be substituted is an element A having an ionic radius slightly larger than that of lithium in the ion crystal, it is presumed that since the element A is distorted in a direction in which an interatomic distance partially increases with respect to the original crystal structure, lithium ions easily move in the crystal structure, and the ionic conductivity at a low temperature is improved. For example, when the element A is an element existing as a divalent or higher valent cation, a plurality of lithium ions are substituted with ions of one element A, and in this case, the lithium ions act in a direction in which a grid volume decreases. Thus, the crystal grid constant and the crystal volume of the solid electrolyte are not necessarily smaller than the crystal grid constant and the crystal volume of a conventional solid electrolyte (for example, Li₆PS₅Cl) that is not substituted with the element A. On the other hand, when a part of lithium is substituted with a metal element having an ionic radius of more than 120 μm in the 4-fold coordination or the 6-fold coordination in the ion crystal, it is presumed that the ionic conductivity at a low temperature is not improved due to a crystal structure in which distortion is too large with respect to the original crystal structure.

It should be noted that “-4” in the space group “F-43m” represents a target element of a four-fold rotation-inversion axis, and should be originally indicated by “4” with an upper bar “-”. It is confirmed by powder X-ray diffraction measurement that the solid electrolyte has the crystal structure attributable to the space group F-43m. The powder X-ray diffraction measurement is performed by the following procedure. An airtight sample holder for X-ray diffraction measurement is filled with a solid electrolyte powder to be measured in an argon atmosphere having a dew point of −50° C. or lower. Powder X-ray diffraction measurement is performed using an X-ray diffractometer (“MiniFlex II” from Rigaku Corporation). A CuKa ray is used as a radiation source, a tube voltage is 30 kV, and a tube current is 15 mA. The diffracted X-ray passes through a K@ filter having a thickness of 30 μm and is detected by a high-speed one-dimensional detector (model number: D/teX Ultra 2). A sampling width is 0.01°, a scanning speed is 5°/min, a divergence slit width is 0.625°, a light receiving slit width is 13 mm (OPEN), and a scattering slit width is 8 mm. The obtained X-ray diffraction pattern is subjected to automatic analysis processing using PDXL (analysis software, manufactured by Rigaku Corporation). Here, “background refinement” and “Auto” are selected in a work window of the PDXL software, and refinement is performed such that an intensity error between an actually measured pattern and a calculated pattern is 4000 or less. Background processing is performed by this refinement, and based on the result obtained by subtracting a baseline, a value of peak intensity of each diffraction line, a value of a crystal grid constant a, and the like are obtained.

With respect to the ionic radius of the metal element, for the metal element providing both the 4-fold coordination and the 6-fold coordination in the ion crystal, the ionic radius in both the 4-fold coordination and the 6-fold coordination needs to be more than 59 μm and 120 μm or less. For the metal element providing only one of the 4-fold coordination and the 6-fold coordination in the ion crystal, the ionic radius in the 4-fold coordination or the 6-fold coordination to be able to be provided may be more than 59 μm or more and 120 μm or less. That is, the metal element providing both the 4-fold coordination and the 6-fold coordination in the ion crystal and having an ionic radius of 59 μm or less or more than 120 μm in either the 4-fold coordination or the 6-fold coordination does not correspond to the element A. The ionic radius of the metal element is based on the value described in R. D. Shannon, Acta Crystallogr., Sect. A, 32 751 (1976).

In the solid electrolyte, a degree of substitution DS (%) of the element A represented by the following formula 1 is preferably 0.1% or more and 5% or less.

DS={[A]/([Li]+m[A])}×100 1

In the formula 1, [Li] is a content ratio of the lithium based on the number of atoms. [A] is a content ratio of the element A based on the number of atoms. m is the valence of the element A in the ion crystal.

Since a part of lithium is substituted with the element A at such a degree of substitution, the ionic conductivity at a low temperature is further improved.

The valence of the element A in the ion crystal is preferably 2 or more. Since the lithium ion has a value of +1, for example when the valence of the element A in the ion crystal is +2, two lithium ions are substituted with ions of one element A, and when the valence of the element A in the ion crystal is +3, three lithium ions can be substituted with ions of one element A. In such a case, by substituting a plurality of lithium ions with ions of one element A while maintaining the crystal structure, the occupancy of lithium ions at the 48h site is reduced, so that the ionic conductivity at a low temperature tends to be further improved.

The element A is preferably a metal element having an ionic radius of more than 59 μm and 100 μm or less in the 4-fold coordination and the 6-fold coordination in the ion crystal. By using the element A having such an ion size, the interatomic distance (grid size) in the crystal structure is further optimized, for example, whereby the ionic conductivity at a low temperature is further improved.

The solid electrolyte is preferably represented by the following formula 2.

Li_{7-mx-y}AₓPS_{6-y}Ha_{y} 2

In the formula 2, A is the element A. Ha is chlorine, bromine, or iodine. xis a number of 0.01 or more and 0.3 or less. y is a number of 0.2 or more and 1.8 or less. m is a number equal to the valence of the element Ain the ion crystal.

When the solid electrolyte has such a composition, the ionic conductivity at a low temperature is further improved.

A lithium ion energy storage device according to an embodiment of the present invention is a lithium ion energy storage device containing the solid electrolyte. In the lithium ion energy storage device, since a solid electrolyte having excellent ionic conductivity at a low temperature is used, sufficient charge-discharge performance at a low temperature is exhibited.

Hereinafter, a solid electrolyte and a lithium ion energy storage device according to one embodiment of the present invention will be sequentially described in detail.

### <Solid Electrolyte>

The solid electrolyte according to an embodiment of the present invention has the crystal structure attributable to the space group F-43m. The solid electrolyte may have the crystal structure attributing to the space group F-43m. The solid electrolyte is a cubic crystal and has an Argyrodite-type crystal structure.

The crystal grid constant a in the solid electrolyte is not particularly limited, and is preferably in a range of 9.852±0.010 A, and more preferably in a range of 9.852±0.006 Å. When the crystal grid constant of the solid electrolyte is within the above range, the Argyrodite-type crystal structure not containing the element A is maintained as it is, and the ionic conductivity at a low temperature tends to further increase. When the crystal grid constant of the solid electrolyte is equal to or greater than the lower limit, shortening of an ion diffusion path is suppressed, and the ionic conductivity at a low temperature further increases. 9.852 Å is the crystal grid constant a of the Argyrodite-type solid electrolyte represented by Li₆PS₅Cl measured by the powder X-ray diffraction measurement method.

The solid electrolyte contains lithium, phosphorus, sulfur, and the element A. The element A is a metal element having an ionic radius of more than 59 μm and 120 μm or less in the 4-fold coordination and the 6-fold coordination in the ion crystal. Usually, the solid electrolyte may be a solid electrolyte containing lithium, phosphorus, and sulfur, in which a part of lithium in the solid electrolyte (for example, Li₆PS₅Cl) having the Argyroclite-type crystal structure is substituted with the element A.

Examples of the element A include sodium (Na, the valence in the ion crystal +1, the ionic radius in the 4-fold coordination 99 μm, the ionic radius in the 6-fold coordination 102 μm), calcium (Ca, the valence in the ion crystal +2, no 4-fold coordination, the ionic radius in the 6-fold coordination 100 μm), scandium (Sc, the valence in the ion crystal +3, no 4-fold coordination, the ionic radius in the 6-fold coordination 74.5 μm), palladium (Pd, the valence in the ion crystal +2, the ionic radius in the 4-fold coordination 64 μm, the ionic radius in the 6-fold coordination 86 μm), silver (A_{g}, the valence in the ion crystal +1, the ionic radius in the 4-fold coordination 100 μm, the ionic radius in the 6-fold coordination 115 μm), and indium (In, the valence in the ion crystal +3, the ionic radius in the 4-fold coordination 62 μm, the ionic radius in the 6-fold coordination 80 μm).

The ionic radius of the element A in the 4-fold coordination and the 6-fold coordination in the ion crystal is preferably 62 μm or more, and more preferably 70 μm, 80 μm, or 90 μm or more in some cases. On the other hand, the ionic radius is preferably 110 μm or less, and more preferably 100 pm or less. By substituting lithium with the element A having an ionic radius in the above range, a degree of distortion of the crystal structure, a crystal grid size, and the like are optimized, whereby the ionic conductivity at a low temperature is further improved.

The valence of the element Ain the ion crystal is preferably 2 or more, and more preferably 2 or 3. That is, the element A preferably exists as a cation having a valence of +2 or +3. When the element A having a valence of 2 or more in the ion crystal is used, a plurality of lithium ions are substituted with ions of one element A, and therefore, the occupancy of lithium ions at the 48h site is reduced, and the ionic conductivity at a low temperature tends to be further improved.

As the element A, sodium, calcium, and indium are preferable, and sodium is more preferable.

Regarding a degree of substitution of the element A with respect to lithium, a value obtained by the following formula 1 is defined as the degree of substitution DS (%) of the element A in the solid electrolyte.

DS={[A]/([Li]+m[A])}×100 1

In the formula 1, [Li] is the content ratio based on the number of atoms (mole number) of the lithium. [A] is a content ratio of the element A based on the number of atoms. m is the valence of the element A in the ion crystal.

For example, when the element A is a metal element Al (Na or the like) existing as a cation having a valence of +1, the degree of substitution DS is represented by the following formula 1-1. When the element A is a metal element A2 (Ca or the like) existing as a cation having a valence of +2, the degree of substitution DS is represented by the following formula 1-2. When the element A is a metal element A3 (In or the like) existing as a cation having a valence of +3, the degree of substitution DS is represented by the following formula 1-3.

DS={[A1]/([Li]+[A1])}×100 1-1

DS={[A2]/([Li]+2×[A2])}×100 1-2

DS={[A3]/([Li]+3×[A3])}×100 1-3

In the formulas 1-1, 1-2, and 1-3, [Li] is the content ratio based on the number of atoms of the lithium. [A1] is the content ratio of the element A1 based on the number of atoms. [A2] is the content ratio of the element A2 based on the number of atoms. [A3] is the content ratio of the element A3 based on the number of atoms.

The lower limit of the degree of substitution DS is preferably 0.1%, more preferably 0.2%, still more preferably 0.4%, and even more preferably 0.6%. For example, when the element A is calcium or the like, the lower limit of the degree of substitution DS is additionally preferably 1.0%, and more preferably 2.0% in some cases. By setting the degree of substitution DS to be equal to or greater than the lower limit, an action due to the inclusion of the element A more sufficiently occurs, and the ionic conductivity at a low temperature can be sufficiently enhanced. As the reason why a good effect is produced in a range where the degree of substitution DS is relatively large when the element A is calcium, it is presumed that since the ionic radius in the ion crystal is not too large and the valence is 2, even when the degree of substitution DS is relatively large, the distortion of the crystal structure is small, and calcium ions easily provide six coordinations and can enter a site (for example, a hexahedral site such as the 4d site) other than the 48h site occupied by lithium.

The upper limit of the degree of substitution DS is, for example, 10%, preferably 5%, more preferably 4%, and still more preferably 3%. The degree of substitution DS may be additionally preferably 2% or less, more preferably 1% or less, and still more preferably less than 1%. By setting the degree of substitution DS to be equal to or less than the upper limit, the state of a favorable crystal structure is maintained, and the ionic conductivity at a low temperature may further increase. For example, when the element A is an element (for example, sodium or the like) having a relatively large ionic radius in the ion crystal and existing as a cation having a valence of +1, the interatomic distance is likely to increase with respect to the original crystal structure, and the distortion of the crystal structure is large. When the element A is an element (for example, indium or the like) having a relatively small ionic radius in the ion crystal and existing as a cation having a valence of +3, the interatomic distance is likely to be conversely narrowed with respect to the original crystal structure, and the distortion of the crystal structure is large. Therefore, when the element A is such an element, the degree of substitution DS in a relatively low range tends to be preferable.

The solid electrolyte preferably contains halogen as an element other than lithium, phosphorus, sulfur, and the element A. Examples of the halogen include chlorine, bromine, and iodine, and chlorine is preferable.

The content ratio of each constituent element in the solid electrolyte is not particularly limited as long as the solid electrolyte can have a predetermined crystal structure. The lower limit of the content ratio of lithium to phosphorus in the solid electrolyte is preferably 5.0, and more preferably 5.2, 5.4, 5.6, 5.8 or 5.9 in terms of the molar ratio (based on the number of atoms) in some cases. The upper limit of the content ratio of lithium is preferably 5.98, and more preferably 5.96, 5.94, 5.92 or 5.9 in some cases.

The lower limit of the content ratio of sulfur to phosphorus is preferably 4, more preferably 4.5, still more preferably 4.9, and even more preferably 5 in terms of a molar ratio. The upper limit of the content ratio of sulfur is preferably 6, more preferably 5.5, still more preferably 5.1, and even more preferably 5.

The lower limit of the content ratio of the element A to phosphorus is preferably 0.01, more preferably 0.02, still more preferably 0.03, and even more preferably 0.04 in terms of the molar ratio. For example, when the element A is calcium or the like, the lower limit of the content ratio of the element A is additionally preferably 0.08, and more preferably 0.12. By setting the content ratio of the element A to be equal to or greater than the lower limit, the ionic conductivity at a low temperature tends to further increase. On the other hand, the upper limit of the content ratio of the element A is, for example, 0.6, preferably 0.3, and more preferably 0.2. For example, when the element A is sodium, indium, or the like, the content ratio of the element A is additionally preferably 0.1 or less, more preferably 0.06 or less, and still more preferably less than 0.06. By setting the content ratio of the element A to be equal to or less than the upper limit, the ionic conductivity at a low temperature tends to further increase.

The lower limit of the content ratio of halogen to phosphorus is preferably 0.2 and more preferably 0.5 in terms of the molar ratio. The upper limit of the content ratio of halogen is preferably 1.8, and more preferably 1.5. The content ratio of halogen is more preferably 1.

The solid electrolyte may further contain elements other than lithium, phosphorus, sulfur, the element A, and halogen. However, the content ratio of the other element to phosphorus in the solid electrolyte is, for example, preferably less than 0.01, and more preferably less than 0.001 in terms of the molar ratio, and the solid electrolyte may not substantially contain the other element.

The solid electrolyte is preferably represented by the following formula 2.

Liz-ₘₓ-_{y}AₓPS₆-_{y}Ha_{y} 2

In the formula 2, A is the element A. Ha is chlorine, bromine, or iodine. x is a number of 0.01 or more and 0.3 or less. y is a number of 0.2 or more and 1.8 or less. m is a number equal to the valence of the element Ain the ion crystal.

The lower limit of x is 0.01, preferably 0.02, more preferably 0.03, and still more preferably 0.04. For example, when the element A is calcium or the like, the lower limit of x is additionally preferably 0.08, and more preferably 0.12. By setting x to be equal to or greater than the lower limit, the ionic conductivity at a low temperature tends to further increase. On the other hand, the upper limit of the x is 0.3, and preferably 0.2. For example, when the element A is sodium, indium, or the like, the x is additionally preferably 0.1 or less, more preferably 0.06 or less, and still more preferably less than 0.06. By setting x to be equal to or less than the upper limit, the ionic conductivity at a low temperature tends to further increase.

The lower limit of the y is 0.2, and preferably 0.5. The upper limit of the y is 1.8, and preferably 1.5. The y is more preferably 1.

The m is 1 when the element A is, for example, sodium and silver, 2 when the element A is, for example, calcium and palladium, and 3 when the element A is scandium and indium.

The lower limit of the ionic conductivity of the solid electrolyte at −30° C. is preferably 0.9×10⁻⁴ S/cm, more preferably 1.0×10⁻⁴ S/cm, and still more preferably 1.1×10⁻⁴ S/cm. When the ionic conductivity of the solid electrolyte at −30° C. is equal to or greater than the lower limit, the charge-discharge performance of the lithium ion energy storage device at a low temperature can be further improved.

The ionic conductivity of the solid electrolyte is determined by measuring an alternating-current impedance by the following method. Under an argon atmosphere having a dew point of −50° C. or lower, 120 mg of the sample powder is put into a powder molder of 10 mm in inner diameter, and then subjected to uniaxial pressing at 50 MPa or less with the use of a hydraulic press. After pressure release, 120 mg of SUS 316 L powder as a current collector is put on an upper surface of the sample, and then subjected to uniaxial pressing at 50 MPa or less with the use of the hydraulic press again. Next, 120 mg of SUS 316 L powder as a current collector is put on a lower surface of the sample, and then subjected to uniaxial pressing at 360 MPa for 5 minutes to obtain a pellet for ionic conductivity measurement. This pellet for ionic conductivity measurement is inserted into an HS cell from Hohsen Corp. to measure the alternating-current impedance at a predetermined temperature. The measurement conditions are an applied voltage amplitude of 20 mV, and a frequency range of 1 MHz to 100 mHz.

The shape of the solid electrolyte is not particularly limited, and is usually granular, massive, or the like. The solid electrolyte can be suitably used as an electrolyte of a lithium ion energy storage device such as a lithium ion secondary battery. Among them, the solid electrolyte can be particularly suitably used as an electrolyte of an all-solid-state battery. The solid electrolyte can be used for any of a positive electrode layer, an isolation layer, a negative electrode layer and the like in the lithium ion energy storage device.

### <Method of Producing Solid Electrolyte>

A method of producing the solid electrolyte is not particularly limited, and examples of the production method include a method of preparing a precursor containing lithium, phosphorus, sulfur, and the element A, and firing the precursor. The solid electrolyte is preferably produced entirely under an inert atmosphere such as an argon atmosphere.

As a method of preparing the precursor, a mechanical milling method, a melt quenching method, a liquid phase method, or another method can be adopted. For example, in the case of the mechanical milling method, a precursor can be obtained by using a compound containing Li, P, S, and the element A as raw materials at a predetermined ratio corresponding to the composition of a target solid electrolyte, and subjecting these materials to a mechanical milling treatment. As the raw materials, Li₂S, P₂S₅, LiCl, NaCl, CaCl₂, InCl₃, LiBr, NaBr, CaBr₂, InBr₃, Na₂S, CaS, InS, and the like can be used.

The firing conditions of the precursor are not particularly limited as long as sufficient heating to such an extent that it can be confirmed by powder X-ray diffraction measurement that the crystal structure attributable to the space group F-43m has been formed is performed. For example, the firing temperature can be, for example, 450° C. or higher and 550° C. or lower. The treatment time can be set to 1 hour or more and 24 hours or less, for example.

### <Lithium Ion Energy Storage Device>

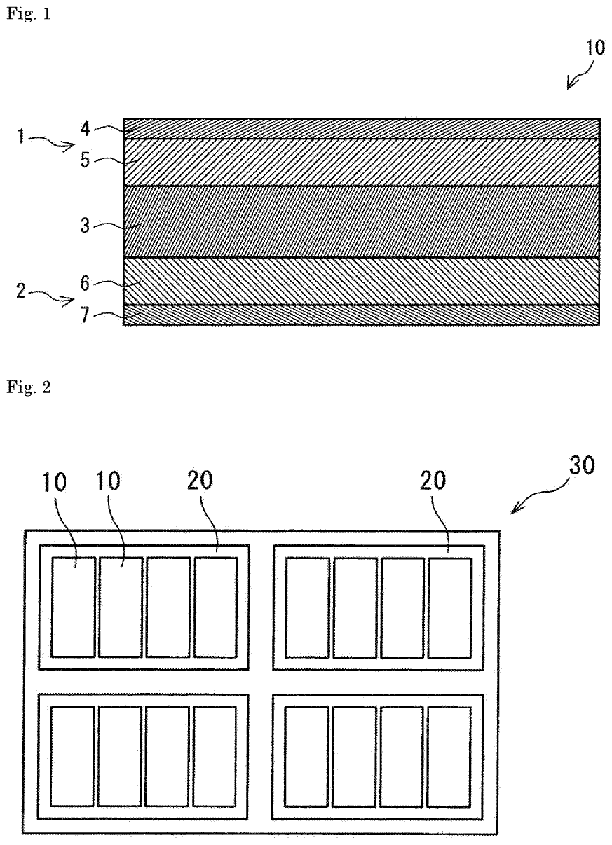

Hereinafter, as an embodiment of the lithium ion energy storage device of the present invention, an all-solid-state battery will be described as a specific example. A lithium ion energy storage device 10 of FIG. 1 is an all-solid-state battery, and is a secondary battery in which a positive electrode layer 1 and a negative electrode layer 2 are arranged with an isolation layer 3 interposed therebetween. The positive electrode layer 1 includes a positive electrode substrate 4 and a positive active material layer 5, and the positive electrode substrate 4 is an outermost layer of the positive electrode layer 1. The negative electrode layer 2 includes a negative electrode substrate 7 and a negative active material layer 6, and the negative electrode substrate 7 is an outermost layer of the negative electrode layer 2. In the lithium ion energy storage device 10 shown in FIG. 1, the negative active material layer 6, the isolation layer 3, the positive active material layer 5, and the positive electrode substrate 4 are stacked in this order on the negative electrode substrate 7.

The lithium ion energy storage device 10 contains the solid electrolyte according to an embodiment of the present invention in at least one of the positive electrode layer 1, the negative electrode layer 2, and the isolation layer 3. More specifically, the solid electrolyte according to an embodiment of the present invention is contained in at least one of the positive active material layer 5, the negative active material layer 6, and the isolation layer 3. Since the lithium ion energy storage device 10 contains the solid electrolyte, good charge-discharge performance at a low temperature is exhibited.

The lithium ion energy storage device 10 may also use a solid electrolyte other than the solid electrolyte according to an embodiment of the present invention. Examples of other solid electrolytes include sulfide-based solid electrolytes, oxide-based solid electrolytes, dry polymer electrolytes, gel polymer electrolytes, and pseudo solid electrolytes other than the solid electrolyte, and the sulfide-based solid electrolytes are preferable. A plurality of different types of solid electrolytes may be contained in one layer of the lithium ion energy storage device 10, or different solid electrolytes may be contained in each layer.

Examples of the sulfide-based solid electrolyte include Li₂S—P₂S₅, Li₂S—P₂S₅-LiI, Li₂S—P₂S₅-LiCl, Li₂S—P₂S₅-LiBr, Li₂S—P₂S₅-Li₂O, Li₂S—P₂S₅-Li₂O—LiI, Li₂S—P₂S₅-Li₃N, Li₂S—SiS₂, Li₂S—SiS₂-LiI, Li₂SSiS₂-LiBr, Li₂S—SiS₂-LiCl, Li₂S—SiS₂—B₂S₃—LiI, Li₂S—SiS₂—P₂S₅—LiI, Li₂S—B2S₃, Li₂S—P₂S₅—ZmS₂n (provided that m and n are positive numbers, and Z is any of Ge, Zn, and Ga), Li₂S—GeS₂, Li₂S—SiS₂—Li₃PO₄, Li₂S—SiS₂—Li—MO_{y} (provided that x and y are positive numbers, and M is any of P, Si, Ge, B, Al, Ga, and In), and Li₁₀GeP₂S₁₂.

### [Positive Electrode Layer]

The positive electrode layer 1 includes the positive electrode substrate 4 and the positive active material layer 5 stacked on a surface of the positive electrode substrate 4. The positive electrode layer 1 may have an intermediate layer between the positive electrode substrate 4 and the positive active material layer 5. The intermediate layer can be, for example, a layer containing conductive particles and a resin binder.

### (Positive Electrode Substrate)

The positive electrode substrate 4 has conductivity. Having “conductivity” means having a volume resistivity of 10⁷ Ω·cm or less that is measured in accordance with JIS-H-0505 (1975), and the term “non-conductivity” means that the volume resistivity is more than 10⁷ Ω·cm. As the material of the positive electrode substrate 4, a metal such as aluminum, titanium, tantalum, indium, or stainless steel, or an alloy thereof is used. Among these, aluminum or an aluminum alloy is preferable from the viewpoint of electric potential resistance, high conductivity, and costs. Examples of the positive electrode substrate include a foil and a deposited film, and a foil is preferable from the viewpoint of costs. Therefore, the positive electrode substrate is preferably an aluminum foil or an aluminum alloy foil. Examples of aluminum and the aluminum alloy include A1085P and A3003P specified in JIS-H-4000 (2014).

The lower limit of the average thickness of the positive electrode substrate is preferably 5 μm, and more preferably 10 μm. The upper limit of the average thickness of the positive electrode substrate is preferably 50 pm, and more preferably 40 μm. By setting the average thickness of the positive electrode substrate to be equal to or greater than the lower limit, the strength of the positive electrode substrate can be increased. By setting the average thickness of the positive electrode substrate to be equal to or less than the upper limit, the energy density per volume of the lithium ion energy storage device can be increased. For these reasons, the average thickness of the positive electrode substrate is preferably 5 μm or more and 50 μm or less, and more preferably 10 μm or more and 40 μm or less. The term “average thickness” means an average value of thicknesses measured at any ten points. The same definition applies when the “average thickness” is used for other members and the like.

The intermediate layer is a layer arranged between the positive electrode substrate and the positive active material layer. The intermediate layer contains conductive particles such as carbon particles to reduce contact resistance between the positive electrode substrate and the positive active material layer. The configuration of the intermediate layer is not particularly limited, and includes, for example, a resin binder and conductive particles.

### (Positive Active Material Layer)

The positive active material layer 5 contains a positive active material. The positive active material layer 5 can be formed of a so-called positive composite containing a positive active material. The positive active material layer 5 may contain a mixture or a composite containing a positive active material and a solid electrolyte. The positive active material layer 5 may contain optional components such as a conductive agent, a binder (binding agent), a thickener, a filler, and the like as necessary. One or two or more of these optional components may not be substantially contained in the positive active material layer 5.

The positive active material contained in the positive active material layer 5 can be appropriately selected from known positive active materials usually used for lithium ion secondary batteries and all-solid-state batteries. As the positive active material, a material capable of occluding and releasing lithium ions is usually used. Examples of the positive active material include lithium transition metal composite oxides having an α—NaFeO₂-type crystal structure, lithium transition metal oxides having a spinel-type crystal structure, polyanion compounds, chalcogenides, and sulfur. Examples of the lithium transition metal composite oxide having an α—NaFeO₂-type crystal structure include Li[LiₓNi₁₋ₓ]O₂ (0≤X<0.5), Li[LiₓNi_{y}Co_{(1-x-y)}]O₂ (0≤x<0.5, 0<y<1), Li[LiₓNi_{y}Mn_{β}Co_{(1-x-y-β)}]O₂ (0≤x<0.5, 0<y, 0<β, 0.5<y+β<1). Examples of the lithium transition metal oxide having a spinel-type crystal structure include LiₓMn₂O₄ and LiₓNi_{y}Mn_{(2-y)}O₄. Examples of the polyanion compound include LiFePO₄, LiMnPO₄, LiNiPO₄, LiCoPO₄, Li₃V₂(PO₄)₃, Li₂MnSiO₄ and Li₂CoPO₄F. Examples of the chalcogenides include titanium disulfide, molybdenum disulfide, and molybdenum dioxide. Apart of atoms or polyanions in these materials may be substituted with atoms or anion species composed of other elements. A surface of the positive active material may be coated with an oxide such as lithium niobate, lithium titanate, or lithium phosphate. In the positive active material layer, one of these positive active materials may be used singly, or two or more of these positive active materials may be mixed and used.

The average particle size of the positive active material is preferably 0.1 μm or more and 20 μm or less, for example. By setting the average particle size of the positive active material to be equal to or greater than the upper limit, the positive active material is easily manufactured or handled. By setting the average particle size of the positive active material to be equal to or less than the upper limit, the electron conductivity of the positive active material layer is improved. Here, the term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher, a classifier, and the like are used to obtain the particles in a predetermined shape. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner.

The lower limit of the content of the positive active material in the positive active material layer 5 is preferably 10% by mass, more preferably 30% by mass, and still more preferably 50% by mass. The upper limit of the content of the positive active material is preferably 90% by mass, and more preferably 80% by mass. By setting the content of the positive active material within the above range, the electric capacity of the lithium ion energy storage device 10 can be further increased.

When the positive active material layer 5 contains a solid electrolyte, the lower limit of the content of the solid electrolyte is preferably 10% by mass, and more preferably 20% by mass. The upper limit of the content of the solid electrolyte in the positive active material layer 5 is preferably 90% by mass, more preferably 70% by mass, and still more preferably 50% by mass. By setting the content of the solid electrolyte within the above range, the electric capacity of the lithium ion energy storage device can be further increased. When the solid electrolyte according to an embodiment of the present invention is used for the positive active material layer 5, the content of the solid electrolyte according to an embodiment of the present invention in an all solid electrolyte in the positive active material layer 5 is preferably 50% by mass or more, more preferably 70 by mass or more %, still more preferably 90% by mass or more, and even more preferably substantially 100% by mass.

A mixture of the positive active material and the solid electrolyte is a mixture prepared by mixing the positive active material, the solid electrolyte, and the like by mechanical milling or the like. For example, the mixture of the positive active material and the solid electrolyte can be obtained by mixing a particulate positive active material, a particulate solid electrolyte, and the like. Examples of the composite of the positive active material and the solid electrolyte include a composite having a chemical or physical bond between the positive active material and the solid electrolyte or the like, and a composite obtained by mechanically combining the positive active material and the solid electrolyte or the like. The composite has the positive active material, the solid electrolyte, and the like present in one particle, and examples thereof include those in which the positive active material, the solid electrolyte, and the like form an aggregated state, and those in which a film containing the solid electrolyte or the like is formed on at least a part of a surface of the positive active material.

The conductive agent is not particularly limited as long as it is a material exhibiting conductivity. Examples of such a conductive agent include graphite; carbon blacks such as furnace black and acetylene black; metals; and conductive ceramics. Examples of the shape of the conductive agent include a powdery shape and a fibrous shape. Among these, acetylene black is preferable from the viewpoint of electron conductivity and the like.

The lower limit of the content of the conductive agent in the positive active material layer 5 is preferably 1% by mass, and more preferably 3% by mass. The upper limit of the content of the conductive agent is preferably 10% by mass, and more preferably 9% by mass. By setting the content of the conductive agent within the above range, the electric capacity of the lithium ion energy storage device can be further increased. For these reasons, the content of the conductive agent is preferably 1% by mass or more and 10% by mass or less, and more preferably 3% by mass or more and 9% by mass or less.

Examples of the binder include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; and polysaccharide polymers.

The lower limit of the content of the binder in the positive active material layer 5 is preferably 1% by mass, and more preferably 3% by mass. The upper limit of the content of the binder is preferably 10% by mass, and more preferably 9% by mass. When the content of the binder is in the above range, the active material can be stably held. For these reasons, the content of the binder is preferably 1% by mass or more and 10% by mass, and more preferably 3% by mass or more and 9% by mass or less.

Examples of the thickener include polysaccharide polymers such as carboxymethylcellulose (CMC) and methylcellulose. When the thickener has a functional group reactive with lithium and the like, the functional group may be deactivated by methylation or the like in advance.

The filler is not particularly limited. Examples of the filler include polyolefins such as polypropylene and polyethylene, silica, alumina, zeolite, glass, and alumina silicate.

The positive active material layer 5 may contain a typical nonmetal element such as B, N, P, F, Cl, Br, or I, a typical metal element such as Li, Na, Mg, Al, K, Ca, Zn, Ga, or Ge, or a transition metal element such as Sc, Ti, V, Cr, Mn, Fe, Co, Ni, Cu, Mo, Zr, Nb, or W as a component other than the positive active material, the conductive agent, the binder, the thickener, and the filler.

The lower limit of the average thickness of the positive active material layer 5 is preferably 30 μm, and more preferably 60 μm. The upper limit of the average thickness of the positive active material layer 5 is preferably 1000 μm, and more preferably 500 μm. By setting the average thickness of the positive active material layer 5 to be equal to or greater than the lower limit, a lithium ion energy storage device having a high energy density can be obtained. By setting the average thickness of the positive active material layer 5 to be equal to or less than the upper limit, the size of the lithium ion energy storage device can be reduced.

### [Negative Electrode Layer]

The negative electrode layer 2 has the negative electrode substrate 7 and the negative active material layer 6 disposed on the negative electrode substrate 7 directly or via an intermediate layer. The configuration of the intermediate layer is not particularly limited, and for example can be selected from the configurations exemplified for the positive electrode layer.

(N_{ega}tive electrode substrate)

The negative electrode substrate 7 exhibits conductivity. As the material of the negative electrode substrate 7, a metal such as copper, nickel, stainless steel, nickel-plated steel, or aluminum, or an alloy thereof is used. Among these, copper or a copper alloy is preferable. Examples of the negative electrode substrate include a foil and a vapor deposited film, and a foil is preferable from the viewpoint of cost. Therefore, the negative electrode substrate is preferably a copper foil or a copper alloy foil. Examples of the copper foil include a rolled copper foil and an electrolytic copper foil.

The lower limit of the average thickness of the negative electrode substrate 7 is preferably 3 μm, and more preferably 5 μm. The upper limit of the average thickness of the negative electrode substrate 7 is preferably 30 μm, and more preferably 20 μm. By setting the average thickness of the negative electrode substrate to be equal to or greater than the lower limit, the strength of the negative electrode substrate 7 can be increased. By setting the average thickness of the negative electrode substrate to be equal to or less than the upper limit, the energy density per volume of the lithium ion energy storage device can be increased. For these reasons, the average thickness of the negative electrode substrate 7 is preferably 3 μm or more and 30 μm or less, and more preferably 5 μm or more and 20 μm or less.

### (Negative Active Material Layer)

The negative active material layer 6 contains a negative active material. The negative active material layer 6 can be formed of a so-called negative composite containing a negative active material. The negative active material layer 6 may contain a mixture or a composite containing a negative active material and a solid electrolyte. The negative active material layer 6 contains optional components such as a conductive agent, a binder, a thickener, a filler, or the like as necessary. The types and suitable contents of the optional components in the negative active material layer are the same as those of the optional components in the positive active material layer described above. One or two or more of these optional components may not be substantially contained in the negative active material layer.

The negative active material layer 6 may contain a typical nonmetal element such as B, N, P, F, Cl, Br, or I, a typical metal element such as Li, Na, Mg, Al, K, Ca, Zn, Ga, or Ge, or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

The negative active material can be appropriately selected from known negative active materials usually used for lithium ion secondary batteries and all-solid-state batteries. As the negative active material, a material capable of occluding and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, graphite and non-graphitic carbon are preferable. In the negative active material layer, one of these materials may be used singly, or two or more of these materials may be mixed and used.

The term “graphite” refers to a carbon material in which an average grid distance (d₀₀₂) of a (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average grid distance (d₀₀₂) of the (002) plane determined by the X-ray diffraction method before charge-discharge or in the discharged state is 0.34 nm or more and 0.42 nm or less. A crystallite size Lc of the non-graphitic carbon is usually 0.80 to 2.0 nm. Examples of the non-graphitic carbon include hardly graphitizable carbon and easily graphitizable carbon. Examples of the non-graphitic carbon include a material derived from resin, a material derived from petroleum pitch, and a material derived from alcohol.

Here, the “discharged state” refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge-discharge are sufficiently released from the carbon material that is the negative active material.

The “hardly graphitizable carbon” refers to a carbon material in which the d₀₀₂ is 0.36 nm or more and 0.42 nm or less. The hardly graphitizable carbon usually has a property that it is difficult to form a graphite structure having a three-dimensional lamination regularity among non-graphitic carbon.

The “easily graphitizable carbon” refers to a carbon material in which the d₀₀₂ is 0.34 nm or more and less than 0.36 nm. The easily graphitizable carbon usually has a property that it is easy to form a graphite structure having a three-dimensional lamination regularity among non-graphitic carbon.

The average particle size of the negative active material can be, for example, 1 μm or more and 100 μm or less. By setting the average particle size of the negative active material to be equal to or greater than the lower limit, the negative active material is easily produced or handled. By setting the average particle size of the negative active material to be equal to or less than the upper limit, the electron conductivity of the positive active material layer is improved. A crusher, a classifier, and the like are used to obtain the particles in a predetermined shape. The crushing method and the powder classification method can be selected from, for example, the methods exemplified for the positive electrode layer.

When the negative active material layer 6 contains a solid electrolyte, the lower limit of the content of the solid electrolyte is preferably 10% by mass, and more preferably 20% by mass. The upper limit of the content of the solid electrolyte in the negative active material layer 6 is preferably 90% by mass, more preferably 70% by mass, and still more preferably 50% by mass. By setting the content of the solid electrolyte within the above range, the electric capacity of the lithium ion energy storage device can be further increased. When the solid electrolyte according to an embodiment of the present invention is used for the negative active material layer 6, the content of the solid electrolyte according to an embodiment of the present invention in an all solid electrolyte in the negative active material layer 6 is preferably 50% by mass or more, more preferably 70 by mass or more %, still more preferably 90% by mass or more, and even more preferably substantially 100% by mass.

The mixture or composite of the negative active material and the solid electrolyte can be obtained by replacing the positive active material with the negative active material in the mixture or composite of the positive active material and the solid electrolyte described above.

The lower limit of the average thickness of the negative active material layer 6 is preferably 30 μm, and more preferably 60 μm. The upper limit of the average thickness of the negative active material layer 6 is preferably 1000 μm, and more preferably 500 μm. By setting the average thickness of the negative active material layer 6 to be equal to or greater than the lower limit, a lithium ion energy storage device having a high energy density can be obtained. By setting the average thickness of the negative active material layer 6 to be equal to or less than the upper limit, the size of the lithium ion energy storage device can be reduced.

### [Isolation Layer]

The isolation layer 3 contains a solid electrolyte. As the solid electrolyte contained in the isolation layer 3, various solid electrolytes can be used in addition to the solid electrolyte according to an embodiment of the present invention described above, and among them, it is preferable to use a sulfide-based solid electrolyte. The content of the solid electrolyte in the isolation layer 3 is preferably 70% by mass or more, more preferably 90 by mass or more %, still more preferably 99% by mass or more, and even more preferably substantially 100% by mass in some cases. When the solid electrolyte according to an embodiment of the present invention is used for the isolation layer 3, the content of the solid electrolyte according to an embodiment of the present invention in an all solid electrolyte in the isolation layer 3 is preferably 50% by mass or more, more preferably 70 by mass or more %, still more preferably 90% by mass or more, and even more preferably substantially 100% by mass.

The isolation layer 3 may contain optional components such as an oxide such as Li₃PO₄, a halogen compound, a binder, a thickener, and a filler. The optional components such as a binder, a thickener, and a filler can be selected from the materials exemplified for the positive active material layer.

The lower limit of the average thickness of the isolation layer 3 is preferably 1 μm, and more preferably 3 μm. The upper limit of the average thickness of the isolation layer 3 is preferably 50 μm, and more preferably 20 μm. By setting the average thickness of the isolation layer 3 to be equal to or greater than the lower limit, it is possible to reliably insulate the positive electrode and the negative electrode. By setting the average thickness of the isolation layer 3 to be equal to or less than the upper limit, the energy density of the lithium ion energy storage device can be increased.

The lithium ion energy storage device of the present embodiment can be mounted as an energy storage unit (battery module) configured by assembling a plurality of lithium ion energy storage devices on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique according to an embodiment of the present invention may be applied to at least one lithium ion energy storage device included in the energy storage unit.

The energy storage apparatus according to an embodiment of the present invention includes two or more lithium ion energy storage devices and one or more lithium ion energy storage devices according to the above embodiment (hereinafter referred to as “second embodiment”). The technique according to an embodiment of the present invention may be applied to at least one lithium ion energy storage device included in the energy storage apparatus according to the second embodiment, one lithium ion energy storage device according to the above embodiment may be provided, and one or more lithium ion energy storage devices not according to the above embodiment may be provided, or two or more lithium ion energy storage devices according to the above embodiment may be provided. FIG. 2 illustrates an example of an energy storage apparatus 30 according to the second embodiment, formed by further assembling energy storage units 20 in each of which two or more electrically connected lithium ion energy storage devices 10 are assembled. The energy storage apparatus 30 may include a busbar (not illustrated) for electrically connecting two or more lithium ion energy storage devices 10, a busbar (not illustrated) for electrically connecting two or more energy storage units 20, and the like. The energy storage unit 20 or the energy storage apparatus 30 may include a state monitor (not illustrated) that monitors the state of one or more lithium ion energy storage devices.

<Method of Producing Lithium Ion Energy Storage Device>

The method for manufacturing a lithium ion energy storage device according to an embodiment of the present invention can be performed by a generally known method except that the solid electrolyte according to an embodiment of the present invention is used for preparation of at least one of the positive electrode layer, the isolation layer, and the negative electrode layer. Specifically, the production method includes, for example, (1) providing a positive composite, (2) providing a material for an isolation layer, (3) providing a negative composite, and (4) stacking a positive electrode layer, the isolation layer, and a negative electrode layer. Hereinafter, each step will be described in detail.

### (1) Step of Providing Positive Composite

In this step, a positive composite for forming a positive electrode layer (positive active material layer) is usually prepared. A method of preparing the positive composite is not particularly limited, and can be appropriately selected according to the purpose. Examples thereof include a mechanical milling treatment of a material of the positive composite, compression molding of a material of the positive composite, and sputtering using a target material of the positive active material. When the positive composite contains a mixture or a composite containing a positive active material and a solid electrolyte, this step can include mixing the positive active material and the solid electrolyte using, for example, a mechanical milling method or the like to prepare a mixture or a composite of the positive active material and the solid electrolyte.

### (2) Step of Providing Material for Isolation Layer

In this step, a material for forming the isolation layer is usually prepared. The material for the isolation layer is usually a solid electrolyte. The solid electrolyte as the material for the isolation layer can be prepared by a conventionally known method. For example, a predetermined material can be obtained by a mechanical milling method. The material for the isolation layer may be prepared by heating a predetermined material to a melting temperature or higher by a melt quenching method, melting and mixing both materials at a predetermined ratio, and quenching the mixture. Examples of other methods of synthesizing the material for the isolation layer include a solid phase method of sealing under reduced pressure and firing, a liquid phase method such as dissolution precipitation, a gas phase method (PLD), and firing under an argon atmosphere after mechanical milling.

### (3) Step of Providing Negative Composite

In this step, a negative composite for forming a negative electrode layer (negative active material layer) is usually prepared. A specific method of preparing the negative composite is the same as that for the positive composite. When the negative composite contains a mixture or a composite containing a negative active material and a solid electrolyte, this step can include mixing the negative active material and the solid electrolyte using, for example, a mechanical milling method or the like to prepare a mixture or a composite of the negative active material and the solid electrolyte.

### (Stacking Step)

In this step, for example, a positive electrode layer having a positive electrode substrate and a positive active material layer, an isolation layer, and a negative electrode layer having a negative electrode substrate and a negative active material layer are stacked. In this step, the positive electrode layer, the isolation layer, and the negative electrode layer may be sequentially formed in this order, or vice versa, and the order of formation of each layer is not particularly limited. The positive electrode layer is formed, for example, by pressure-molding a positive electrode substrate and a positive composite, the isolation layer is formed by pressure-molding the material for the isolation layer, and the negative electrode layer is formed by pressure-molding a negative electrode substrate and a negative composite. The positive electrode layer, the isolation layer, and the negative electrode layer may be stacked by pressure-molding the positive electrode substrate, the positive composite, the material for the isolation layer, the negative composite, and the negative electrode substrate at a time. The positive electrode layer and the negative electrode layer may be each formed in advance, and stacked by pressure-molding with the isolation layer.

### [Other Embodiments]

The present invention is not limited to the aforementioned embodiments, and, in addition to the aforementioned aspects, can be carried out in various aspects with alterations and/or improvements being made. For example, the lithium ion energy storage device according to the present invention may include a layer other than the positive electrode layer, the isolation layer, and the negative electrode layer. In the lithium ion energy storage device according to the present invention, one or a plurality of layers may contain a liquid. The lithium ion energy storage device according to the present invention may be a capacitor or the like in addition to the lithium ion energy storage device which is a secondary battery.

### EXAMPLES

Hereinafter, the present invention will be described in more detail with reference to Examples, but the present invention is not limited to the following Examples.

### Example 1

Li₂S (0.4373 g), P₂S₅ (0.4141 g), LiCl (0.1500 g), and CaCl₂ (0.0103 g) as raw material compounds were mixed in an agate mortar. This mixture was treated as follows by a dry ball mill method. The mixture was charged into a closed 80 mL zirconia pot containing 160 g of zirconia balls with a diameter of 4 mm. These steps were performed under an argon atmosphere having a dew point of −50° C. or lower. The mechanical milling treatment was performed 25 times for 1 hour at the number of revolutions of 370 rpm by a planetary ball mill (from FRITSCH, model number: Premium line P-7) to obtain a precursor. The mechanical milling treatment was performed with a pause of 2 minutes every hour. The obtained precursor was molded into pellets in a glove box in which an argon atmosphere having a dew point of −50° C. or lower was maintained. The precursor was heated at 500° C. for 4 hours to be fired, and thus to obtain a solid electrolyte of Example 1 represented by a composition formula Li₆₋ₘₓAₓS₅Cl (A═Ca, m=2, x=0.025).

### Examples 2 to 13, Comparative Examples 1 to 3

Solid electrolytes of Examples 2 to 13 and Comparative Examples 1 to 3 represented by the composition formulas described in Tables 1 to 4 were obtained by the same operation as in Example 1 except that the amounts of LiCl and CaCl₂ or an alternative of CaCl₂ were appropriately changed so as to obtain the solid electrolytes represented by the composition formulas described in Tables 1 to 4. In Examples 7 and 8, NaCl was used in place of CaCl₂, in Examples 9 to 13, InC1₃ was used in place of CaCl₂, in Comparative Example 1, CaCl₂ was not used, in Comparative Example 2, MgCl₂ was used in place of CaCl₂, and in Comparative Example 3, KCl was used in place of CaCl₂.

Tables 1 to 4 also show the degree of substitution of the element A represented by the above formula 1 in the obtained solid electrolyte. In each table, Examples and Comparative Examples partially overlapping for comparison are described.

### [Evaluation]

### (1) Powder X-Ray Diffraction Measurement

Powder X-ray diffraction measurement was performed by the above method. As an airtight sample holder for X-ray diffraction measurement, trade name “general-purpose atmosphere separator” from Rigaku Corporation was used. Each of the solid electrolytes of Examples and Comparative Examples had a diffraction pattern attributable to the space group F-43m. That is, it could be confirmed that the crystal structure was maintained also in each of the solid electrolytes of Examples 1 to 13 and Comparative Examples 2 and 3 in which a part of lithium was substituted with the element A with respect to the solid electrolyte (Li₆PS₅Cl) of Comparative Example 1. In Tables 1 to 4, the crystal grid constant a of each solid electrolyte obtained from the X-ray diffraction pattern is shown.

### (2) Ionic Conductivity

The ionic conductivity at −30° C. of each of the solid electrolytes of Examples and Comparative Examples was determined by measuring the alternating-current impedance by the above-described method using “VMP-300” from Bio-Logic Science Instruments. The measurement results are shown in Tables 1 to 4.

In the solid electrolytes of Comparative Example 1 and Example 12, the ionic conductivity at 25° C. and 50° C. was determined by measuring the alternating-current impedance by the above-described method using “VMP-300” from Bio-Logic Science Instruments. The measurement results are shown in Table 3.

TABLE 1

| | Composition | | | | | Ionic |
|---|---|---|---|---|---|---|
| | | | | Degree of | Crystal grid | conductivity |
| | Li₆₋ₘₓAₓPS₅Cl | | | substitution | constant a | (S/cm) |
| | A | m | x | (%) | (Å) | −30° C. |
| Comparative | — | — | 0 | 0 | 9.8518 | 0.79 × 10⁻⁴ |
| Example 1 | | | | | | |
| Example 1 | Ca | 2 | 0.025 | 0.42 | 9.8537 | 1.16 × 10⁻⁴ |
| Example 2 | Ca | 2 | 0.050 | 0.83 | 9.8522 | 1.44 × 10⁻⁴ |
| Example 3 | Ca | 2 | 0.100 | 1.67 | 9.8495 | 1.48 × 10⁻⁴ |
| Example 4 | Ca | 2 | 0.150 | 2.50 | 9.8486 | 1.54 × 10⁻⁴ |
| Example 5 | Ca | 2 | 0.200 | 3.33 | 9.8511 | 1.49 × 10⁻⁴ |
| Example 6 | Ca | 2 | 0.300 | 5.00 | 9.8464 | 1.36 × 10⁻⁴ |

TABLE 2

| | Composition | | | | | Ionic |
|---|---|---|---|---|---|---|
| | | | | Degree of | Crystal grid | conductivity |
| | Li₆₋ₘₓAₓPS₅Cl | | | substitution | constant a | (S/cm) |
| | A | m | x | (%) | (Å) | −30° C. |
| Comparative | — | — | 0 | 0 | 9.8518 | 0.79 × 10⁻⁴ |
| Example 1 | | | | | | |
| Example 7 | Na | 1 | 0.025 | 0.42 | 9.8578 | 0.96 × 10⁻⁴ |
| Example 8 | Na | 1 | 0.050 | 0.83 | 9.8592 | 1.47 × 10⁻⁴ |

TABLE 3

| | Composition | | | | | Ionic | Ionic | Ionic |
|---|---|---|---|---|---|---|---|---|
| | | | | Degree of | Crystal grid | conductivity | conductivity | conductivity |
| | Li₆₋ₘₓAₓPS₅Cl | | | substitution | constant a | (S/cm) | (S/cm) | (S/cm) |
| | A | m | x | (%) | (Å) | −30° C. | 25° C. | 50° C. |
| Comparative | — | — | 0 | 0 | 9.8518 | 0.79 × 10⁻⁴ | 2.18 × 10⁻³ | 6.10 × 10⁻³ |
| Example 1 | | | | | | | | |
| Example 9 | In | 3 | 0.025 | 0.42 | 9.8529 | 1.14 × 10⁻⁴ | — | — |
| Example 10 | In | 3 | 0.050 | 0.83 | 9.8509 | 1.21 × 10⁻⁴ | — | — |
| Example 11 | In | 3 | 0.075 | 1.25 | 9.8484 | 1.08 × 10⁻⁴ | — | — |
| Example 12 | In | 3 | 0.100 | 1.67 | 9.8477 | 0.90 × 10⁻⁴ | 1.94 × 10⁻³ | 5.31 × 10⁻³ |
| Example 13 | In | 3 | 0.125 | 2.08 | 9.8467 | 0.87 × 10⁻⁴ | — | — |

TABLE 4

| | Composition | | | | | | Ionic |
|---|---|---|---|---|---|---|---|
| | | | | Degree of | | Crystal grid | conductivity |
| | Li₆₋ₘₓAₓPS₅Cl | | | substitution | Ionic radius of A | constant a | (S/cm) |
| | A | m | x | (%) | (pm) | (Å) | −30° C. |
| Comparative | Mg | 2 | 0.025 | 0.42 | Mg²⁺: 57 (4-fold coordination), | 9.8509 | 0.76 × 10⁻⁴ |
| Example 2 | | | | | 72 (6-fold coordination) | | |
| Comparative | — | — | 0 | 0 | — | 9.8518 | 0.79 × 10⁻⁴ |
| Example 1 | | | | | | | |
| Example 9 | In | 3 | 0.025 | 0.42 | In³⁺: 62 (4-fold coordination), | 9.8529 | 1.14 × 10⁻⁴ |
| | | | | | 80 (6-fold coordination) | | |
| Example 7 | Na | 1 | 0.025 | 0.42 | Na⁺: 99 (4-fold coordination), | 9.8578 | 0.96 × 10⁻⁴ |
| | | | | | 102 (6-fold coordination) | | |
| Example 1 | Ca | 2 | 0.025 | 0.42 | Ca²⁺: 100 (6-fold coordination) | 9.8537 | 1.16 × 10⁻⁴ |
| Comparative | K | 1 | 0.025 | 0.42 | K⁺: 137 (4-fold coordination), | 9.8562 | 0.74 × 10⁻⁴ |
| Example 3 | | | | | 138 (6-fold coordination) | | |

As shown in Tables 1 to 3, it is found that the ionic conductivity at a low temperature of −30° C. is improved in the solid electrolytes of Examples 1 to 13 containing the element A (Ca, Na, or In) as compared with the solid electrolyte of Comparative Example 1 not containing the element A. On the other hand, as shown in Table 3, regarding the ionic conductivity at a room temperature of 25° C. and at a high temperature of 50° C., when a predetermined amount of the element A (In) is contained, the ionic conductivity conversely decreases. It is found that the ionic conductivity at a low temperature (−30° C.) tends to be different from the ionic conductivity at a room temperature (25° C.) or a high temperature (50° C.).

In Table 4, the measurement results of Examples and Comparative Examples in which the degrees of substitution of the substitution elements (element A, and Mg and K) were made equal to 0.42% are summarized. It is found that the solid electrolyte of Comparative Example 2 containing Mg having an ionic radius smaller than Li in the ion crystal and the solid electrolyte of Comparative Example 3 containing K having an ionic radius exceeding 120 μm in the ion crystal have lower ionic conductivity than the solid electrolyte of Comparative Example 1. That is, it is found that the ionic conductivity at a low temperature (−30° C.) is improved by containing the element A whose ionic radius in the ion crystal is suitably larger than that of Li. It is found that the ionic conductivity is particularly remarkably improved in a case of substitution with Ca or In which is a polyvalent ion in the ion crystal.

### INDUSTRIAL APPLICABILITY

The solid electrolyte according to the present invention is suitably used as a solid electrolyte of a lithium ion energy storage device such as an all-solid-state battery and an energy storage apparatus.

### DESCRIPTION OF REFERENCE SIGNS

1: positive electrode layer

2: negative electrode layer

3: isolation layer

4: positive electrode substrate

5: positive active material layer

6: negative active material layer

7: negative electrode substrate

10: lithium ion energy storage device (all-solid-state battery)

20: energy storage unit

30: energy storage apparatus

1. A solid electrolyte having a crystal structure attributable to a space group F-43m and containing lithium, phosphorus, sulfur, and an element A, wherein the element A is a metal element having an ionic radius of more than 59 pm and 120 pm or less in 4-fold coordination and 6-fold coordination in an ion crystal.

2. The solid electrolyte according to claim 1, wherein a degree of substitution DS of the element A represented by the following formula 1 is 0.1° A or more and 5% or less:
DS={[A]/([Li]+m[A])}×100 1
wherein [Li] is a content ratio of the lithium based on the number of atoms, [A] is a content ratio of the element A based on the number of atoms, and m is a valence of the element A in the ion crystal.

3. The solid electrolyte according to claim 1, wherein the element A has a valence of 2 or more in the ion crystal.

4. The solid electrolyte according to claim 1, wherein the element A is a metal element having an ionic radius of more than 59 μm and 100 pm or less in the 4-fold coordination and the 6-fold coordination in the ion crystal.

5. The solid electrolyte according to claim 2, wherein the element A is sodium, and the degree of substitution DS represented by the formula 1 is 0.1% or more and less than 1%.

6. The solid electrolyte according to claim 1, represented by the following formula 2:
Li_{7-mx-y}AₓPS_{6-y}Ha_{y} 2
wherein A is the element A, Ha is chlorine, bromine, or iodine, x is a number of 0.01 or more and 0.3 or less, y is a number of 0.2 or more and 1.8 or less, and m is a number equal to the valence of the element A in the ion crystal.

7. A lithium ion energy storage device comprising the solid electrolyte according to claim 1.

8. An energy storage apparatus comprising:
two or more lithium ion energy storage devices; and
one or more of the lithium ion energy storage devices according to claim 7.
